(19) United States
(12) Patent Application Publication
(10) Pub. No.: US 2010/0073222 A1
(43) Pub. Date: Mar. 25, 2010

(54) FMWC SIGNAL GENERATOR AND RADAR APPARATUS USING FMCW SIGNAL GENERATOR

(75) Inventors: Toshiya Mitomo, Kawagoe-shi (JP); Hiroaki Hoshino, Yokohama-shi (JP); Osamu Watanabe, Chigasaki-shi (JP); Shoji Otaka, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/407,817

(22) Filed: Mar. 20, 2009

(30) Foreign Application Priority Data
Sep. 19, 2008 (JP) 2008-241766

(51) Int. Cl. G01S 13/00

(52) U.S. Cl. 342/175

(57) ABSTRACT

An FMCW signal generator includes a frequency divider to divide the FMCW signal at a preset dividing ratio, a reference signal generator to periodically generate a reference signal at a second time interval not less than a loop time constant set for a PLL, a frequency of the reference signal being discretely swept within a range of fc±Δf (fc is a center frequency, and Δf is a frequency sweep width) at a first time interval not more than the loop time constant, a comparison unit to compare the frequency divided signal with the reference signal to generate a comparison result signal corresponding to a phase difference between the frequency divided signal and the reference signal, a loop filter to filter the comparison result signal to generate a control voltage signal, and a VCO to have an oscillation frequency thereof controlled by the control voltage signal.

### CROSS-REFERENCE TO RELATED APPLICATIONS

This application is based upon and claims the benefit of priority from prior Japanese Patent Application No. 2008-241766, filed Sep. 19, 2008, the entire contents of which are incorporated herein by reference.

### BACKGROUND OF THE INVENTION

1. Field of the Invention

The present invention relates to an FMCW signal generator and a radar apparatus using an FMCW signal generator.

2. Description of the Related Art

An FMCW radar apparatus that uses frequency modulated continuous wave (FMCW) signals is a radar apparatus using radio signals. In the FMCW radar apparatus, an FMCW signal transmitted from its transmitter is reflected by a target, and the reflection wave is received by its receiver. In the receiver, the reflection wave (received signal) is multiplied by a transmission signal (FMCW signal) transmitted from the transmitter when the reflection wave is received, thereby measuring the distance to the target or the relative speed of the target, utilizing the fact that the frequency of a signal output from a multiplier is determined from the difference in time between the received signal and transmission signal. FMCW signals for radars have to be swept substantially linearly with respect to the time.

In general, FMCW signal generators capable of executing such frequency sweep are realized by a digital signal processor (DSP) for generating digital values that indicate the discrete frequencies of an FMCW signal, and a direct digital frequency synthesizer (DDFS) that comprises a digital-to-analog converter (DAC) for converting the digital value into an analog signal, and an anti-aliasing filter. As methods of producing FMCW signals of a frequency band actually used in radars, the following methods are exemplified, i.e., a method of mixing the output signal of the DDFS and a signals of a carrier frequency (S. Plata “FMCW Radar Transmitter Based on DDS Synthesis” (International Conference on Microwaves, Radar & Wireless Communications, 2006)(Document 1), and a method of utilizing a PLL that includes a frequency divider in which the output signal of the DDFS is used as a reference signal (A. Stelzer, et al. “Fast 77 GHz Chirps with Direct Digital Synthesis and Phase Locked Loop” (Asia-Pacific Microwave Conference 2005) (Document 2).

In general FMCW radar apparatuses, the FM modulation width (frequency sweep width) has to be not less than a few hundred MHz. When using the method described in Document 1, the DDFS has to operate at an extremely high clock frequency to realize such an FM modulation width. Namely, such an extremely high operation frequency is required for the DDFS.

In contrast, if a PLL including a frequency divider (the dividing ratio is set to N) is used and the output signal of the DDFS, serving as a reference signal, is supplied to the PLL as in Document 2, it is sufficient if the frequency of the reference signal is 1/N of that of the FMCW signal. Accordingly, the operation frequency of the DDFS can be greatly reduced, compared to the method of Document 1.

However, if the short-range resolution of FMCW radars is set to, for example, 0.5 m, it is necessary to sweep the frequency of the FMCW signal at the time interval (approx. 3.3 ns) at which radiation propagates over a distance of 0.5 m×2. In this case, it is necessary to operate the PLL at not less than 600 MHz. Namely, it is necessary to set the frequency of the reference signal to 600 MHz or more. Further, if the DAC in the DDFS used to generate the reference signal to the PLL is made to execute n-times oversampling to improve quantized noise, it is necessary to operate the DDFS at a very high frequency of n×600 MHz.

As described above, in FMCW signal generators based on the conventional techniques of Documents 1 and 2, the operation frequency of the reference signal generator for the PLL is very high. This makes it very difficult to realize a one-chip radar transceiver IC or a low-power-consumption radar transceiver IC.

### BRIEF SUMMARY OF THE INVENTION

In accordance with an aspect of the invention, there is provided a frequency modulated continuous wave (FMCW) signal generator using a PLL comprising: a frequency divider to divide an FMCW signal at a preset dividing ratio to obtain a frequency divided signal; a reference signal generator to periodically generate a reference signal at a second time interval not less than a loop time constant set for the PLL, a frequency of the reference signal being discretely swept within a range of fc±Δf (fc is a center frequency, and Δf is a frequency sweep width) at a first time interval not more than the loop time constant; a comparison unit configured to compare the frequency divided signal with the reference signal to generate a comparison result signal corresponding to a phase difference between the frequency divided signal and the reference signal; a loop filter to filter the comparison result signal to generate a control voltage signal; and a voltage control oscillator to have an oscillation frequency thereof controlled by the control voltage signal, to generate the FMCW signal.

In accordance with another aspect of the invention, there is provided a frequency modulated continuous wave (FMCW) signal generator using a PLL comprising: a frequency divider to divide an FMCW signal at a preset dividing ratio to obtain a frequency divided signal; a reference signal generator to periodically generate a reference signal at a second time interval not less than a loop time constant set for the PLL, a frequency of the reference signal being discretely swept within a range of fc±Δf (fc is a center frequency, and Δf is a frequency sweep width) at a first time interval not more than the loop time constant; a comparison unit configured to compare the frequency divided signal with the reference signal to generate a comparison result signal corresponding to a phase difference between the frequency divided signal and the reference signal; a loop filter to filter the comparison result signal to generate a control voltage signal; and a voltage control oscillator to have an oscillation frequency thereof controlled by the control voltage signal, to generate the FMCW signal, wherein the loop time constant for the PLL is set between the first and second time intervals.

In accordance with yet another aspect of the invention, there is provided a radar apparatus comprising: the FMCW signal generator according to claim 1; a power amplifier to amplify, to a preset power level, a FMCW signal generated by the FMCW signal generator, to obtain a transmission signal; an antenna unit configured to transmit the transmission signal into a space and receive a signal reflected from a target to obtain a received signal; a low noise amplifier to amplify the received signal to obtain an amplified signal; and a mixer circuit to multiply the amplified signal by the FMCW signal to obtain an output signal.

### BRIEF DESCRIPTION OF THE SEVERAL VIEWS OF THE DRAWING

FIG. 1 is a block diagram illustrating an FMCW signal generator according to a first embodiment;

FIG. 2 is a graph useful in explaining a reference signal employed in the first embodiment;

FIG. 3 is a graph useful in explaining an FMCW signal employed in the first embodiment;

FIG. 4 is a block diagram illustrating an FMCW signal generator according to a second embodiment;

FIG. 5 is a view illustrating a direct digital frequency synthesizer (DDFS);

FIG. 6 is a block diagram illustrating an FMCW signal generator according to a third embodiment;

FIG. 7 is a block diagram illustrating an FMCW signal generator according to a fourth embodiment;

FIG. 8 is a graph useful in explaining a reference signal and an FMCW signal appearing when an appropriate PLL loop time constant is set;

FIG. 9 is a view useful in explaining a reference signal and an FMCW signal appearing when PLL loop characteristics are set inappropriately;

FIG. 10 is a block diagram illustrating an FMCW radar apparatus according to a fifth embodiment; and

FIG. 11 is a block diagram illustrating a modification of the FMCW radar apparatus according to the fifth embodiment.

### DETAILED DESCRIPTION OF THE INVENTION

Embodiments of the invention will be described with reference to the accompanying drawings.

### First Embodiment

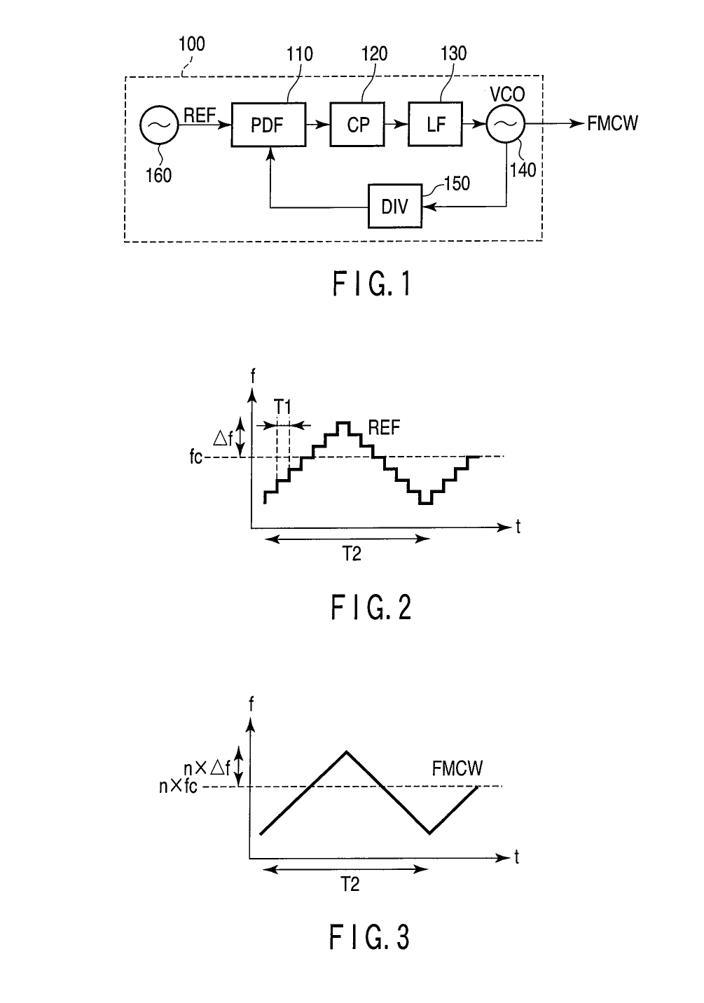

As shown in FIG. 1, an FMCW signal generator 100 according to a first embodiment of the invention includes a phase frequency detector (PFD) 110, a charge pump (CP) 120, a loop filter (LF) 130, a voltage controlled oscillator (VCO) 140, a frequency divider (DIV) 150 and a reference signal generator 160.

The reference signal generator 160 periodically generates a reference signal REF at a second time interval T2, the frequency of which signal is swept discretely within a range of fc±Δf (fc is a center frequency, and Δf is a frequency sweep width) at a first time interval T1 (T1<T2), as is shown in FIG. 2.

The phase frequency detector 110 and the charge pump 120 provide a comparison unit for comparing the reference signal REF output from the reference signal generator 160 with the frequency divided signal output from the frequency divider 150, and outputting a comparison result signal corresponding to the phase difference between the reference signal REF and the frequency divided signal. Namely, the phase frequency detector 110 detects the difference in frequency and phase between the reference signal REF and the frequency divided signal, and outputs a detection signal corresponding to the difference. The detection signal from the phase frequency detector 110 is rectified into a comparison result signal by the charge pump 120. The comparison result signal is filtered by the loop filter 130, whereby a control voltage signal for controlling the oscillation frequency of the VCO 140 is generated.

The phase frequency detector 110, the charge pump 120, the loop filter 130, the VCO 140 and the frequency divider 150 form a phase-locked loop (PLL). The oscillation frequency of the VCO 140 is controlled based on the control voltage signal from the loop filter 130. As a result, the VCO 140 outputs a desired FMCW signal in synchronism with the reference signal REF output from the reference signal generator 160.

The PLL time constant (closed loop time constant) τ is set to fall within a range of the first time interval T1 to the second time interval T2. In other words, the reference signal generator 160 periodically generates the reference signal REF having its frequency discretely swept at the first time interval T1 not more than the loop time constant τ over a range of fc±Δf. For instance, supposing that the first time interval T1 is 10 μs and the second time interval T2 is 500 μs, the time constant τ falls within the range of 10 μs to 500 μs.

It is required that the frequency of the FMCW signal substantially linearly varies in a desired cycle corresponding to the second time interval T2 as shown in FIG. 3. Namely, the frequency sweeping of the FMCW signal has to be iterated in the cycle T2. In the first embodiment, since the PLL time constant τ of the FMCW signal generator is shorter than T2, the frequency sweep of the FMCW signal can be iterated in the cycle T2.

On the other hand, the frequency of the reference signal REF output from the reference signal generator 160 is discretely swept at the first time interval T1. Since the loop time constant τ is longer than the first time interval T1, abrupt frequency changes in the reference signal REF during discrete frequency sweep is smoothed by the PLL, with the result that changes with time in the control voltage signal input to the VCO 140 are also smoothed.

Accordingly, even if the first time interval T1 is set longer than the shortest frequency switching period required for FMCW radars, the oscillation frequency of the VCO 140 substantially linearly varies within a range of N×(fc±Δf) at the second time interval T2. As a result, an FMCW signal that can exhibit such rates of change in frequency at the second time interval T2 as shown in FIG. 3 can be generated.

As described above, in the first embodiment, since the loop time constant τ is set to satisfy the condition T1≦τ≦T2, a highly accurate FMCW signal can be generated even though the reference signal generator 160 operates relatively slowly. This enables the FMCW signal generator to be formed of, for example, a CMOS integrated circuit, and enables low power consumption of the FMCW signal generator.

Further, the FMCW signal employed in the first embodiment can be used for radar apparatuses, in particular, for collision prevention radars installed in vehicles. The FMCW signal can easily satisfy, at low power consumption, the ranging accuracy required for collision prevention radars.

### Second Embodiment

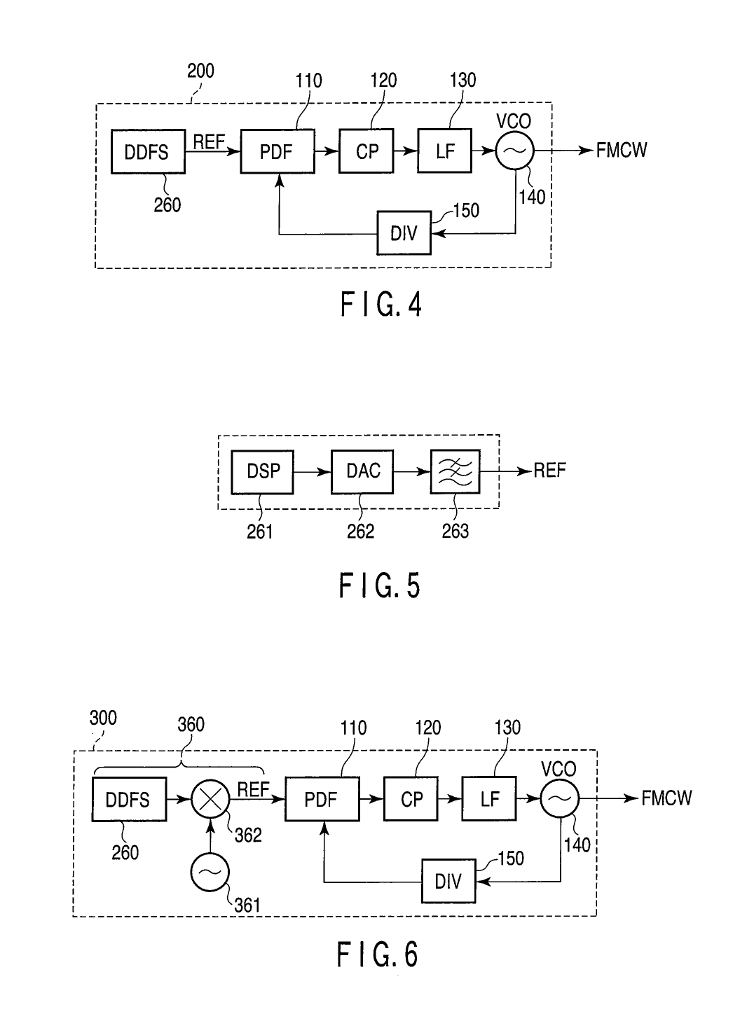

Referring to FIG. 4, a second embodiment of the invention will be described. In an FMCW signal generator 200 according to the second embodiment, a component corresponding to the reference signal generator 160 in the first embodiment is realized by a direct digital frequency synthesizer (DDFS) 260.

The DDFS 260 comprises a digital signal processor (DSP) 261, a digital-to-analog converter (DAC) 262 and an anti-aliasing filter 263.

The DSP 261 generates digital values corresponding to frequencies that discretely vary within the range of fc±Δf at the first time interval T1. The digital values generated by the DSP 261 are converted into analog signals by the DAC 262. The resultant analog signals are subjected to the anti-aliasing filter 263, where their aliasing components are removed. As a result, analog signals discretely swept within the range of fc±Δf at the first time interval T1, which correspond to the reference signals REF output from the reference signal generator 160 of the first embodiment, are generated.

To impart a desired frequency change to an FMCW signal using the reference signal REF, the operation frequency of the DDFS 260 is set to a value not lower than a maximum frequency (Nyquist frequency) that can be assumed by the reference signal REF. Accordingly, the first time interval T1 is equal to the inverse of the Nyquist frequency. Further, to reduce the quantized noise of the DAC 262, the operation frequency (sampling frequency) of the DAC 262 is set to a value obtained by doubling the Nyquist frequency and further multiplying the resultant frequency by N (N: an arbitrary integer). Namely, there may be a case where the DAC 262 executes n-times oversampling.

The second embodiment differs from the first embodiment only in that in the former, the reference signal generator 160 is realized by the DDFS 260, and the first time interval T1 is determined from the Nyquist frequency. In the other points, the second embodiment executes the same operation as the first embodiment to generate a desired FMCW signal. Therefore, in the second embodiment, the loop time constant τ is set to a value between the first and second time intervals T1 and T2, as in the first embodiment.

Specific numerical examples will now be given. When the maximum frequency of the reference signal REF is, for example, 100 kHz, the operation frequency of the DDFS 260 (the sampling frequency of the DAC 262) is set to 200 kHz to satisfy a sampling theorem. This means the case where the oversampling ratio N of the DAC 262 is 1, i.e., where the sampling frequency of the DAC 262 is 200 kHz, and the first time interval T1 is set to 5 μs (=1/200 kHz). On the other hand, the second time interval T2 is set to, for example, 500 μs. At this time, the loop time constant τ is set to a value between 50 μs and 500 μs.

As described above, in the second embodiment, even when the operation frequency of the DDFS 260 (the sampling frequency of the DAC 262), i.e., the inverse of the first time interval T1, is reduced, a highly accurate FMCW signal can be generated, and therefore the FMCW signal generator can be formed of, for example, a CMOS integrated circuit, and low power consumption of the FMCW signal generator can be realized.

### Third Embodiment

Referring then to FIG. 6, a third embodiment of the invention will be described. In an FMCW signal generator 300 according to the third embodiment, a reference signal generator 360 is realized by a DDFS 260, a single-tone signal generator 361 and a single-sideband (SSB) mixer 362. The DDFS 260 is formed of a DSP 261, a DAC 262 and an anti-aliasing filter 263 as in the second embodiment shown in FIG. 5.

In the third embodiment, however, the DDFS 260 outputs a signal with a frequency of (fc±Δf)−fr that is obtained by reducing the frequency fc±Δf by a certain fixed frequency fr, as well as the reference signal REF described in the first and second embodiments. Namely, in the DDFS 260, the DSP 261 generates digital values corresponding to frequencies that discretely vary within the range of (fc±Δf)−fr, at the first time interval T1, the DAC 262 converts the digital values into analog signals, which are output from the DDFS 260 via anti-aliasing filter 263. If fr=fc−Δf, the DDFS 260 outputs only signals with a minimum frequency of (fc−Δf)−fr=0 and a maximum frequency of (fc+Δf)−fr=2Δf, i.e., outputs only signals corresponding to FM frequency shift components of 0 to 2Δf included in a desired FMCW signal.

The single-tone signal generator 361 generates a single tone signal with a fixed frequency fr that is identical to the difference between the frequency (fc+Δf) of the reference signal REF in the first embodiment, and the frequency {(fc+Δf)−fr} of the signal output from the DDFS 260. The SSB mixer 362 multiplies the output signal of the DDFS 260 by the single tone signal output from the single-tone signal generator 361. As a result, the SSB mixer 362 outputs a reference signal REF, the frequency of which is swept discretely within the range of fc±Δf at the first time interval T1, the sweeping being repeated periodically at the second time interval T2, like the reference signal generator 160 of the first and second embodiments. The reference signal REF output from the SSB mixer 362 is supplied to the PLL, which, in turn, generates an FMCW signal.

In the third embodiment, the operation frequency of the DDFS 260 can be further reduced. For instance, if the frequency (carrier frequency: fc=100 kHz) of the reference signal REF is changed by Δf=10 kHz, the minimum frequency and maximum frequency of the signal output from the DDFS 260 are (fc−Δf−fr=0) and (fc+Δf−fr=20 kHz), respectively, and the frequency fr of the single tone signal output from the single-tone signal generator 361 is 90 kHz. Accordingly, in the third embodiment, the operation frequency required for the DDFS 260 is 20 kHz×2=40 kHz since the maximum frequency of the signal output from the DDFS 260 is fc+Δf−fr=20 kHz. Thus, the operation frequency required for the DDFS 260 is significantly reduced, compared to the second embodiment in which the required operation frequency is (100 kHz+10 kHz)×2=220 kHz.

The single-tone signal generator 361 can be easily realized by, for example, a quartz oscillator. Accordingly, the single-tone signal generator 361 can be used as a clock signal source for a digital circuit such as the DAC 262, and the use of the single-tone signal generator 361 does not involve increases in current consumption, or increases in the number of component parts or the area required for them.

The structure employed in the third embodiment after the reference signal generator 360 is the same as that employed in the first and second embodiments. Further, in the third embodiment, the loop time constant τ is set to a value falling between the first and second time intervals T1 and T2, as in the first and second embodiments. In the above-described example, the first time interval T1 is equal to the sampling interval (1/40 kHz=25 μs) of the DAC 262. Therefore, if the frequency sweeping interval T2 of the FMCW signal is 500 μs, the loop time constant τ is set to a value between 25 μs and 500 μs.

### Fourth Embodiment

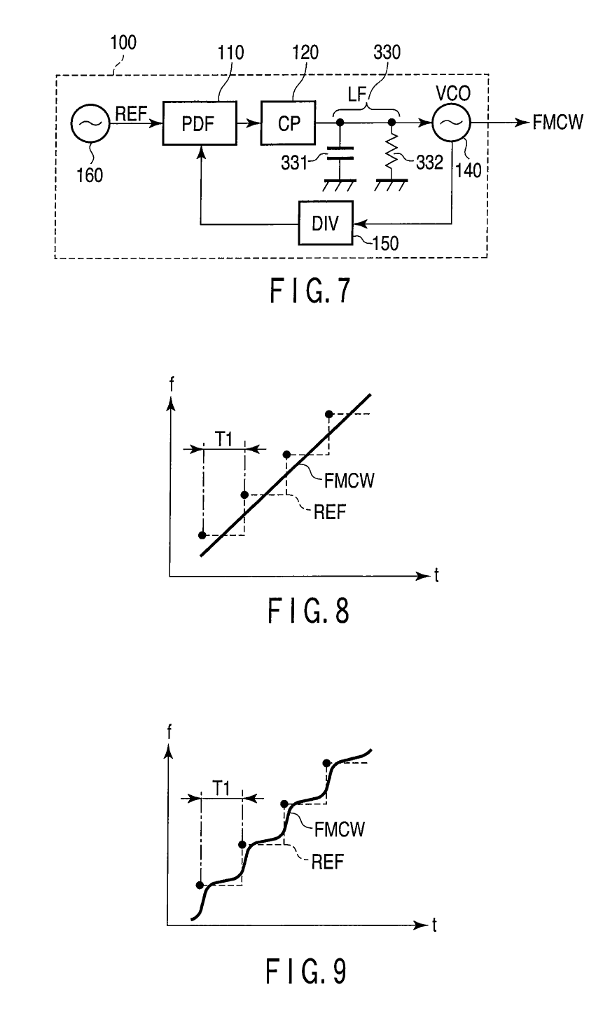

Referring now to FIG. 7, a fourth embodiment of the invention will be described. In a FMCW signal generator 400 according to the fourth embodiment, a low-pass filter (LPF) 330, which comprises a capacitor 441 and a resistor 332 connected in parallel between a line connecting the output terminal of a charge pump 120 to the control input terminal of a VCO 140, and a ground terminal, is used in place of the loop filter 130 of the first embodiment.

The LPF 330 smoothes the comparison result signal output from the charge pump 120 to produce a control voltage signal for the VCO 140. An LPF of another structure may be used in place of the loop filter 130. Alternatively, a filter other than LPFs may be used, if it satisfies the required characteristics.

The loop characteristics of the PLL including the loop time constant τ are expressed by the sensitivity Kv of the VCO 140, the sensitivity Kp of the charge pump 120, the frequency dividing ratio N of the frequency divider 150, and the circuit constant of the loop filter 130. If the loop filter 130 is formed of a primary LPF 330, as shown in FIG. 7, that comprises a capacitor 331 (having a capacitor C) and a resistor 332 (having a resistance R), the transfer function of the entire PLL is given by the following expression (1):

$$\frac{{K}_{P} {K}_{V}}{{NCRs}^{2} + sN + {K}_{P} {K}_{V} R} \qquad ( 1 )$$

where s=jω (ω: the angular frequency of the signal).

The inverse of the angular frequency at which the transfer function expressed by the above expression (1) serves as a pole (i.e., the denomination of the expression is 0), i.e., the loop time constant τ of the PLL, is determined from the above-mentioned constants Kv, Kp, N, C and R, and is set to a value falling between the first and second time intervals T1 and T2.

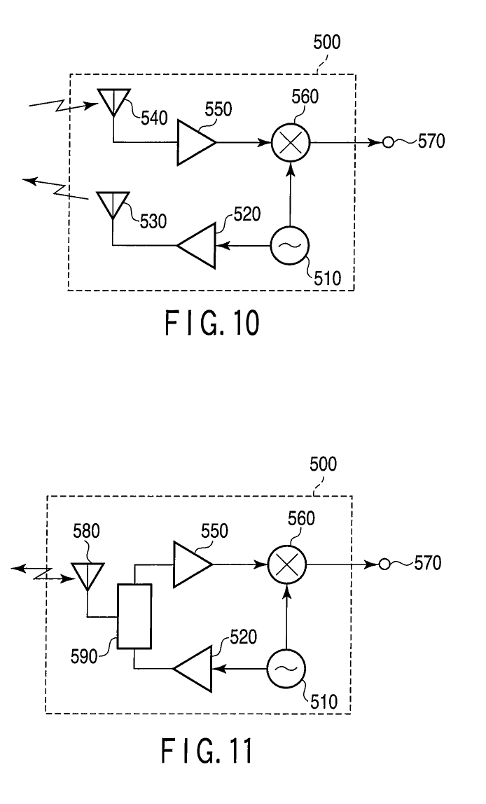

When the LPF 330 is used as the loop filter 130, the frequency sweeping characteristic of the FMCW signal varies as shown in FIGS. 8 and 9, depending on whether the loop characteristic of the PLL is appropriate. FIG. 9 shows a case where an appropriate loop characteristic is not set. In this case, since the comparison result signal from the charge pump 120 is not sufficiently smoothed, the FMCW signal cannot have an appropriate frequency sweeping characteristic.

In contrast, when an appropriate loop characteristic is set, i.e., when it is set to T1≦τ≦T2, the comparison result signal from the charge pump 120 is sufficiently smoothed, and hence the frequency of the FMCW signal is linearly swept as shown in FIG. 8. Thus, an appropriate frequency sweeping characteristic is acquired.

### Fifth Embodiment

Referring to FIG. 10, a fifth embodiment of the invention will be described. FIG. 10 shows an FMCW radar apparatus 500 provided with an FMCW signal generator 510 according to any one of the first to fourth embodiments.

The FMCW signal output from the FMCW signal generator 510 is amplified to a required power level by a power amplifier 520, thereby generating a transmission signal. The transmission signal is transmitted from a transmission antenna 530 into the space, then reflected by a target (not shown), and received by a receiving antenna 540. The signal received by the receiving antenna 540 is amplified in power by a low noise amplifier 550 such as a low-noise amplifier.

A mixer 560 multiples the amplified signal from the low noise amplifier 550 by the FMCW signal from the FMCW signal generator 510, and outputs, to a radar output terminal 570, a sine-wave signal having a frequency corresponding to the distance between the radar apparatus and the target.

In the case of FIG. 10, two antennas, i.e., the transmission antenna 530 and the receiving antenna 540, are employed. However, if a transmission/reception separator 590, such as an isolator or duplexer, is used as shown in FIG. 11, a single antenna 580 can be used in common between the transmitter and receiver sides. Further, an amplifier or a filter may be added to each of the transmitter and receiver.

As described above, the fifth embodiment provides a highly accurate FMCW radar apparatus of much lower power consumption than the prior art apparatuses, since the low-power-consumption FMCW signal generator according to the first, second, third or fourth embodiment is used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A frequency modulated continuous wave (FMCW) signal generator using a PLL comprising:
a frequency divider to divide an FMCW signal at a preset dividing ratio to obtain a frequency divided signal;
a reference signal generator to periodically generate a reference signal at a second time interval not less than a loop time constant set for the PLL, a frequency of the reference signal being discretely swept within a range of fc±Δf (fc is a center frequency, and Δf is a frequency sweep width) at a first time interval not more than the loop time constant;
a comparison unit configured to compare the frequency divided signal with the reference signal to generate a comparison result signal corresponding to a phase difference between the frequency divided signal and the reference signal;
a loop filter to filter the comparison result signal to generate a control voltage signal; and
a voltage control oscillator to have an oscillation frequency thereof controlled by the control voltage signal, to generate the FMCW signal.

2. The generator according to claim 1, wherein the voltage control oscillator is controlled by the control voltage signal to periodically vary the oscillation frequency at the second time interval within a range of N×(fc±Δf) (N is the preset dividing ratio).

3. The generator according to claim 1, wherein the reference signal generator is a direct digital frequency synthesizer (DDFS) which includes:
a digital signal processor to generate a digital value corresponding to a frequency which discretely varies within the range of fc±Δf;
a digital-to-analog converter to convert the digital value into an analog signal; and
an anti-aliasing filter to remove an aliasing component from the analog signal to obtain the reference signal.

4. The generator according to claim 1, wherein the reference signal generator includes:
a digital signal processor to generate a digital value corresponding to a frequency which discretely varies within a range of fc±Δf−fr (fr is a fixed frequency);
a digital-to-analog converter to convert the digital value into an analog signal;
an anti-aliasing filter to remove an aliasing component from the analog signal to obtain a filtered signal; and
a single-sideband mixer to multiply the filtered signal by a single tone signal of the fixed frequency fr to obtain the reference signal.

5. The generator according to claim 1, wherein the loop filter is a low-pass filter which has a circuit constant determined to set the loop time constant to a value between the first and second time intervals.

6. A frequency modulated continuous wave (FMCW) signal generator using a PLL comprising:
a frequency divider to divide an FMCW signal at a preset dividing ratio to obtain a frequency divided signal;
a reference signal generator to periodically generate a reference signal at a second time interval not less than a loop time constant set for the PLL, a frequency of the reference signal being discretely swept within a range of fc±Δf (fc is a center frequency, and Δf is a frequency sweep width) at a first time interval not more than the loop time constant;
a comparison unit configured to compare the frequency divided signal with the reference signal to generate a comparison result signal corresponding to a phase difference between the frequency divided signal and the reference signal;
a loop filter to filter the comparison result signal to generate a control voltage signal; and
a voltage control oscillator to have an oscillation frequency thereof controlled by the control voltage signal, to generate the FMCW signal,
wherein the loop time constant for the PLL is set between the first and second time intervals.

7. A radar apparatus comprising:
the FMCW signal generator according to claim 1;
a power amplifier to amplify, to a preset power level, a FMCW signal generated by the FMCW signal generator, to obtain a transmission signal;
an antenna unit configured to transmit the transmission signal into a space and receive a signal reflected from a target to obtain a received signal;
a low noise amplifier to amplify the received signal to obtain an amplified signal; and
a mixer circuit to multiply the amplified signal by the FMCW signal to obtain an output signal.

8. The apparatus according to claim 7, wherein the antenna unit includes:
a transmission antenna to transmit the transmission signal into the space; and
a receiving antenna to receive the signal reflected from the target.

9. The apparatus according to claim 7, wherein the antenna unit includes:
an antenna to transmit the transmission signal into the space and receive the signal reflected from the target; and
a transmission/reception separator interposed between the antenna, and the power amplifier and the low noise amplifier, and configured to separate an output of the power amplifier from an input of the low noise amplifier.
